(19) United States
(12) Patent Application Publication
(10) Pub. No.: US 2025/0036409 A1
(43) Pub. Date: Jan. 30, 2025

(54) PROCESSOR

(71) Applicant: Fujitsu Limited, Kawasaki-shi (JP)

(72) Inventor: Sota SAKASHITA, Kawasaki (JP)

(73) Assignee: Fujitsu Limited, Kawasaki-shi (JP)

(21) Appl. No.: 18/756,084

(22) Filed: Jun. 27, 2024

(30) Foreign Application Priority Data
Jul. 28, 2023 (JP) 2023-123438

(51) Int. Cl. G06F 9/30

(52) U.S. Cl. CPC G06F 9/30141; G06F 9/3001; G06F 9/30043

(57) ABSTRACT

A processor includes an arithmetic pipeline including an arithmetic unit configured to execute an arithmetic instruction and output arithmetic result data, a load pipeline configured to read first data and second data in parallel from a memory based on a first load instruction, and output the read first data and second data, a selector configured to select the second data when the second data is output from the load pipeline, and select an output of the arithmetic unit when the second data is not output from the load pipeline, and a register file including a first port configured to receive the first data from the load pipeline, a second port configured to receive data from the selector, and a plurality of registers configured to hold data received by the first port or the second port. The first data and the second data are stored in mutually different registers.

### CROSS-REFERENCE TO RELATED APPLICATIONS

This application is based upon and claims the benefit of priority of the prior Japanese Patent Application No. 2023-123438, filed on Jul. 28, 2023, the entire contents of which are incorporated herein by reference.

### FIELD

The embodiments discussed herein are related to processors.

### BACKGROUND

An arithmetic processing unit, that executes instructions for accessing a plurality of locations in a memory area in response to a single instruction, is known. In the arithmetic processing unit of this type, a reservation station executes a plurality of memory accesses, based on decoding of one multi-data indirect load instruction by a decoder, as proposed in Japanese Laid-Open Patent Publication No. 2015-203950, for example.

For example, in a load instruction for loading a plurality of data into a plurality of registers of a register file in parallel, a processing performance of the instruction deteriorates in a case where a pipeline executes a plurality of flows for loading the plurality of data. In addition, in the case where the plurality of data are loaded into the plurality of registers in parallel, a circuit scale increases because the register file is provided with a number of write ports corresponding to the number of data to be loaded.

### SUMMARY

One aspect of the embodiments of the present disclosure improves a processing performance of a processor that executes a load instruction for loading a plurality of data into a plurality of registers of a register file in parallel, while reducing an increase in a circuit scale.

In one aspect of the embodiments of the present disclosure, a processor includes an arithmetic pipeline including an arithmetic unit configured to execute an arithmetic instruction and output arithmetic result data; a load pipeline configured to read first data and second data in parallel from a memory based on a first load instruction, and output the read first data and second data; a selector configured to select the second data when the second data is output from the load pipeline, and select an output of the arithmetic unit when the second data is not output from the load pipeline; and a register file including a first port configured to receive the first data from the load pipeline, a second port configured to receive data from the selector, and a plurality of registers configured to hold data received by the first port or the second port, wherein the first data and the second data are stored in mutually different registers.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating an example of a processor according to one embodiment;

FIG. 2 is an explanatory diagram illustrating an outline of an operation in a case where the processor of FIG. 1 executes a first load instruction;

FIG. 3 is a block diagram illustrating an example of another processor;

FIG. 4 is a block diagram illustrating an example of a GPR renaming table of FIG. 3;

FIG. 5 is an explanatory diagram illustrating an example of an operation in a case where the processor of FIG. 3 executes a load instruction LDP;

FIG. 6 is an explanatory diagram illustrating an example of a pipeline processing of a load-store unit in a case where the processor of FIG. 3 executes a load instruction LDR and the load instruction LDP;

FIG. 7 is an explanatory diagram illustrating an example of a pipeline related to the load instruction LDR executed by the processor of FIG. 3;

FIG. 8 is an explanatory diagram illustrating an example of a pipeline processing of an arithmetic instruction executed by the processor of FIG. 3;

FIG. 9 is a block diagram illustrating an example of a processor according to another embodiment;

FIG. 10 is an explanatory diagram illustrating an example of a pipeline related to the load instruction LDP executed by the processor of FIG. 9;

FIG. 11 is an explanatory diagram illustrating an example of a pipeline processing in a case where the load instruction LDP and the arithmetic instruction are executed in parallel in the processor of FIG. 9; and

FIG. 12 is an explanatory diagram illustrating an example of a pipeline processing in a case where a plurality of load instructions LDP are sequentially executed in the processor of FIG. 9.

### DESCRIPTION OF EMBODIMENTS

Hereinafter, embodiments will be described with reference to the drawings. In the following description, signal lines through which signals are transmitted are designated by names that are the same as signal names of the signals. Although not particularly limited, the processor described below is a superscalar processor and executes instructions in parallel by a pipeline processing. The processor described below may be a scalar processor.

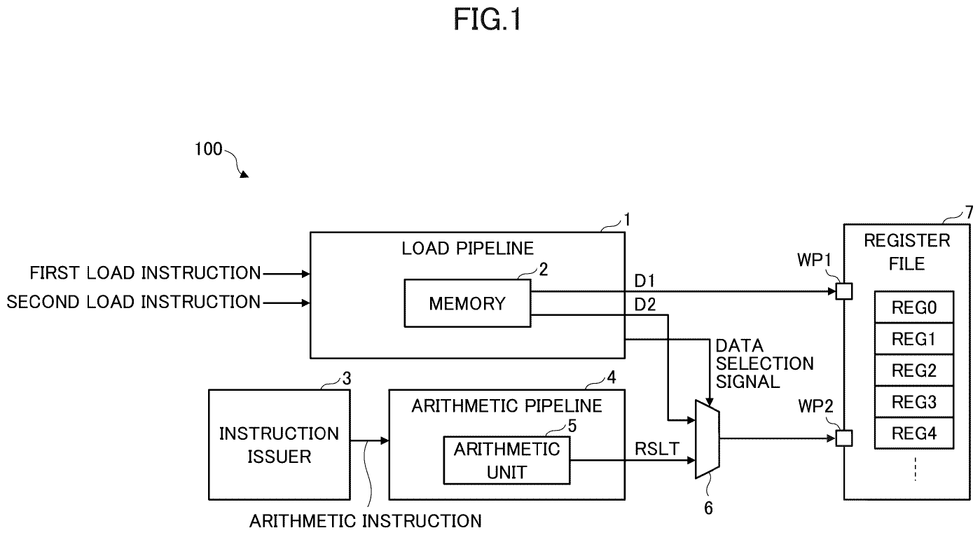

FIG. 1 illustrates an example of a processor according to one embodiment. A processor 100 illustrated in FIG. 1 includes a load pipeline 1 including a memory 2, an instruction issuer 3, an arithmetic pipeline 4 including an arithmetic unit 5, a selector 6, and a register file 7.

The register file 7 includes a plurality of registers REG (REG0, REG1, . . . ), and two write ports WP1 and WP2 for receiving data to be stored in the registers REG. The write port WP1 is provided for receiving data (load data) D1 output from the load pipeline 1. The write port WP2 is provided for receiving data (load data) D2 output from the load pipeline 1, and arithmetic result data RSLT output from the arithmetic pipeline 4.

The data D1 is an example of first data, and the data D2 is an example of second data. The write port WP1 is an example of a first port, and the write port WP2 is an example of a second port.

A bit width of data received by each of the write ports WP1 and WP2 is equal to a bit width of one register REG. That is, a bit width of the data D1 and D2 output from the load pipeline 1 and a bit width of the arithmetic result data RSLT output from the arithmetic pipeline 4 are equal to the bit width of each of the registers REG. Hereinafter, the data held in one register REG may also be referred to as one unit of data.

The load pipeline 1 receives a first load instruction or a second load instruction. The first load instruction is an instruction for updating values of two registers REG by a single instruction. The second load instruction is an instruction for updating the value of one register REG by a single instruction. The load pipeline 1 reads two units of the data D1 and D2 from the memory 2, based on the first load instruction, outputs the data D1 to the write port WP1, and outputs the data D2 to the selector 6. The load pipeline 1 reads one unit of the data D1 from the memory 2, based on the second load instruction, and outputs the data D1 to the write port WP1.

The instruction issuer 3 sequentially issues arithmetic instructions to the arithmetic pipeline 4. The arithmetic pipeline 4 executes the arithmetic instructions sequentially received from the instruction issuer 3 by the arithmetic unit 5, and outputs the arithmetic result data RSLT as an execution result of the operation to the selector 6.

When the selector 6 receives data selection information, the selector 6 selects the data D2 output from the load pipeline 1 and outputs the selected data D2 to the write port WP2. When the selector 6 does not receive the data selection information, the selector 6 selects the arithmetic result data RSLT output from the arithmetic pipeline 4 and outputs the selected arithmetic result data RSLT to the write port WP2.

The data D1 and D2 supplied to the write ports WP1 and WP2 are stored in the two registers REG specified by the first load instruction, respectively. Arithmetic result data RSLT2 supplied to the write port WP2 is stored in the register REG specified by the arithmetic instruction.

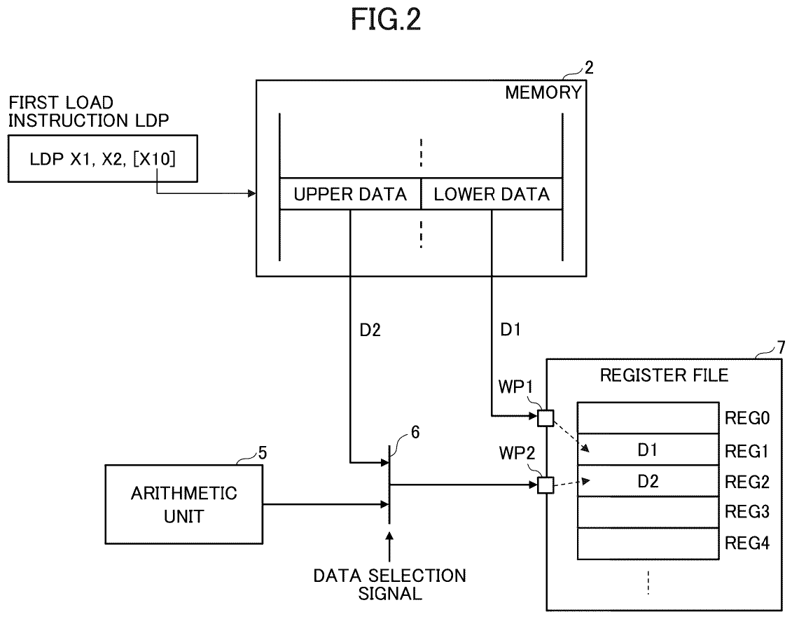

FIG. 2 illustrates an outline of an operation in a case where the processor 100 of FIG. 1 executes the first load instruction. For example, the first load instruction is described as “LDP X1, X2, [X10]” in mnemonic. A code LDP indicates an instruction code of the first load instruction. Codes X1 and X2 indicate the registers REG for storing two units of data read from the memory 2. In this example, the code X1 indicates the register REG1, and the code X2 indicates the register REG2. A code [X10] indicates the registers REG holding addresses of storage areas of the memory 2 from which the data D1 and D2 are read.

The load pipeline 1 that executes the first load instruction reads two units of data D1 and D2 (lower data and upper data) from the memory 2. The load pipeline 1 outputs to the selector 6 a data select signal for causing the selector 6 to select the data D2, at a timing when the data D2 is read from the memory 2. Thus, the data D1 is stored in the register REG1 through the write port WP1, and the data D2 is stored in the register REG2 through the selector 6 and the write port WP2. That is, the data D1 and the data D2 are stored in the mutually different registers REG1 and REG2, respectively.

As described above, in this embodiment, the processor 100 includes the selector 6 between the arithmetic pipeline 4 and the write port WP2 dedicated to writing the arithmetic result data RSLT to the register REG. Hence, the write port WP2 can also be used for writing the data D2, read from the memory 2 based on the first load instruction, to the register REG. As a result, the two registers REG can be updated by the two units of data D1 and D2 read from the memory 2 by the first load instruction, without having to newly provide a write port for the data D2 of the first load instruction. Accordingly, it is possible to improve a processing performance of the processor 100 which executes the first load instruction to load the plurality of data D1 and D2 in parallel to the plurality of registers REG of the register file 7, while reducing an increase in a circuit scale.

Depending on specifications of a processor, there are cases where a plurality of pipelines for memory access instructions or arithmetic instructions are provided, and in such cases, the number of write ports of the register file 7 increases according to the number of pipelines. For this reason, increasing the number of write ports of the register file 7 leads to an increase in an amount of circuitry.

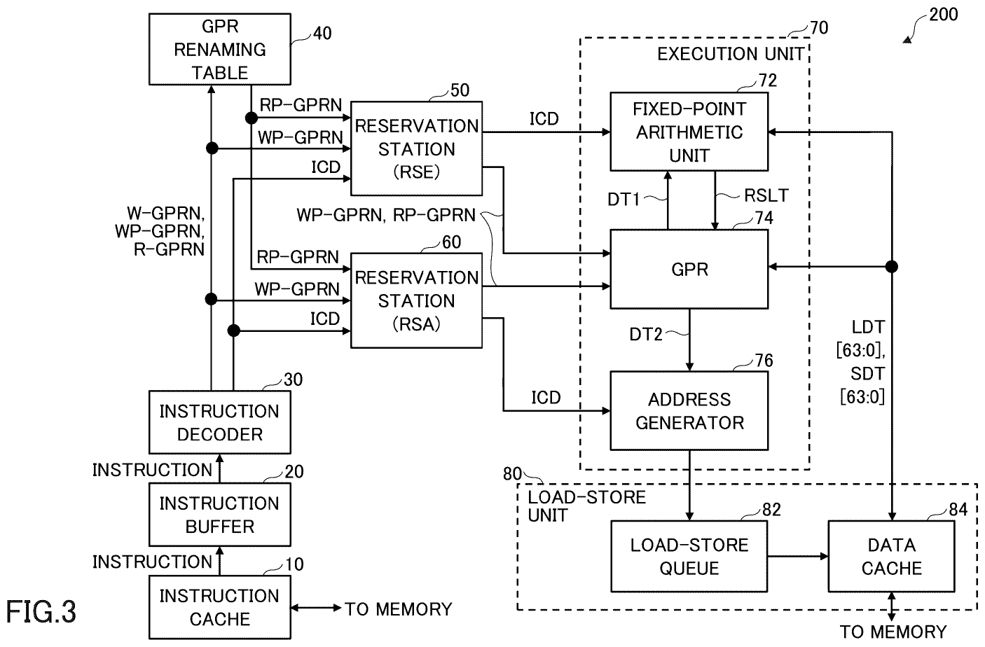

FIG. 3 illustrates an example of another processor. A processor 200 illustrated in FIG. 3 includes an instruction cache 10, an instruction buffer 20, an instruction decoder 30, and a GPR renaming table 40. In addition, the processor 200 includes a reservation station 50 (RSE: Reservation Station for Execution), a reservation station 60 (RSA: Reservation Station for Address), an execution unit 70, and a load-store unit 80.

The execution unit 70 includes a fixed-point arithmetic unit 72, a register (GPR: General Purpose Register) 74, and an address generator 76. The load-store unit 80 includes a load-store queue 82, and a data cache 84.

The GPR 74 includes a plurality of entries for holding data. Hereinafter, each of the plurality of entries included in the GPR 74 may also be referred to as a GPR. Although not particularly limited, a size of each entry of the GPR 74 is 64 bits, for example. The GPR 74 is an example of a register file, and the plurality of entries included in the GPR 74 are examples of registers.

The reservation stations 50 and 60 may also be referred to as the RSE and the RSA, respectively. A reservation station in which functions of the RSE and the RSA are integrated, may be provided in place of the reservation stations 50 and 60.

The instruction cache 10 is a primary cache for holding an instruction transferred from a memory, such as a secondary cache, a main memory, or the like, for example. The instruction cache 10 outputs the instruction held therein to the instruction buffer 20. The instruction held in the instruction cache 10 is an arithmetic instruction, a memory access instruction, or the like. The memory access instruction is a store instruction or a load instruction. The instruction buffer 20 accumulates the instructions transferred from the instruction cache 10, and sequentially outputs the accumulated instructions to the instruction decoder 30 in order.

The instruction decoder 30 decodes the instruction received from the instruction buffer 20. In a case where the instruction decoder 30 decodes the arithmetic instruction, the instruction decoder 30 outputs a write physical register number WP-GPRN, a write logical register number W-GPRN, and a read logical register number R-GPRN to the GPR renaming table 40. Further, in the case where the instruction decoder 30 decodes the arithmetic instruction, the instruction decoder 30 outputs the write physical register number WP-GPRN and an instruction code ICD to the RSE.

In a case where the instruction decoder 30 decodes the load instruction, the instruction decoder 30 outputs the write physical register number WP-GPRN and the write logical register number W-GPRN to the GPR renaming table 40. Further, in the case where the instruction decoder 30 decodes the load instruction, the instruction decoder 30 outputs the write physical register number WP-GPRN and the instruction code ICD to the RSA.

In a case where the instruction decoder 30 decodes the store instruction, the instruction decoder 30 outputs the read logical register number R-GPRN to the GPR renaming table 40. Further, in the case where the instruction decoder 30 decodes the store instruction, the instruction decoder 30 outputs the instruction code ICD to the RSA.

For example, the instruction decoder 30 acquires the write physical register number WP-GPRN using a method called the free listing method, for example. This can prevent the write physical register number WP-GPRN from being simultaneously used by a plurality of instructions.

The GPR renaming table 40 has a number of entries corresponding to a number of logical registers (operands) that can be specified by the arithmetic instruction or the memory access instruction described in a program executed by the processor 200.

The GPR renaming table 40 associates a number assigned to the logical register specified by the arithmetic instruction with a number assigned to the entry (physical register) of the GPR 74 used by the fixed-point arithmetic unit 72. In addition, the GPR renaming table 40 associates a number assigned to the logical register specified by the memory access instruction with a number assigned to the entry (physical register) of the GPR 74 used by the address generator 76.

For example, the GPR renaming table 40 updates the entry of the GPR renaming table 40, based on the write physical register number WP-GPRN and the write logical register number W-GPRN received from the instruction decoder 30. Moreover, the GPR renaming table 40 outputs a read physical register number RP-GPRN to the RSE and the RSA, based on the read logical register number R-GPRN received from the instruction decoder 30.

The write physical register number WP-GPRN indicates a number assigned to the entry (physical register) of the GPR 74 in which the arithmetic result data RLST is updated, or a number assigned to the entry (physical register) of the GPR 74 in which the data is updated by the load instruction. The write logical register number W-GPRN indicates a number assigned to the logical register described in the instruction in association with the write physical register number WP-GPRN.

The read physical register number RP-GPRN indicates a number assigned to the entry (physical register) of the GPR 74 that holds the data used for an operation or a number assigned to the entry (physical register) of the GPR 74 from which the data is read by the store instruction. The read logical register number R-GPRN indicates a number assigned to the logical register described in the instruction in association with the read physical register number RP-GPRN.

The RSE accumulates the arithmetic instructions and speculatively issues the accumulated arithmetic instructions out-of-order to the execution unit 70 in an executable order. An output of the RSE is connected to the GPR 74 and the fixed-point arithmetic unit 72. Further, the RSE outputs the instruction code ICD for executing the arithmetic instruction to the fixed-point arithmetic unit 72, and outputs the write physical register number WP-GPRN and the read physical register number RP-GPRN to the GPR 74.

The fixed-point arithmetic unit 72 reads the data DT1 used for the operation from the entry of the GPR 74, based on the arithmetic instruction received from the RSE, and stores the arithmetic result data RSLT in the entry of the GPR 74.

The RSA accumulates the memory access instructions (load instructions or store instructions) and speculatively issues the accumulated arithmetic instructions out-of-order to the execution unit 70 in an executable order. An output of the RSA for storing the memory access instruction is connected to the GPR 74 and the address generator 76. Further, the RSA outputs the instruction code ICD for executing the memory access instruction to the address generator 76, and outputs the write physical register number WP-GPRN and the read physical register number RP-GPRN to the GPR 74.

The address generator 76 refers to the GPR 74 based on the memory access instruction received from the RSA, reads the data DT2 from the GPR 74, and performs an addition process or the like on the read data DT2, thereby generating an access address. The address generator 76 outputs the generated access address to the load-store unit 80.

The load-store unit 80 accumulates the access addresses received from the address generator 76 in the load-store queue 82, and sequentially uses the accumulated access addresses to access the data cache 84. In a case where the memory access instruction is a load instruction, data LDT is read from the data cache 84, and the data LDT is output to one of the entries of the GPR 74 and the fixed-point arithmetic unit 72. In a case where the memory access instruction is a store instruction, data SDT to be stored, held in one of the entries of the GPR 74, is written to the data cache 84.

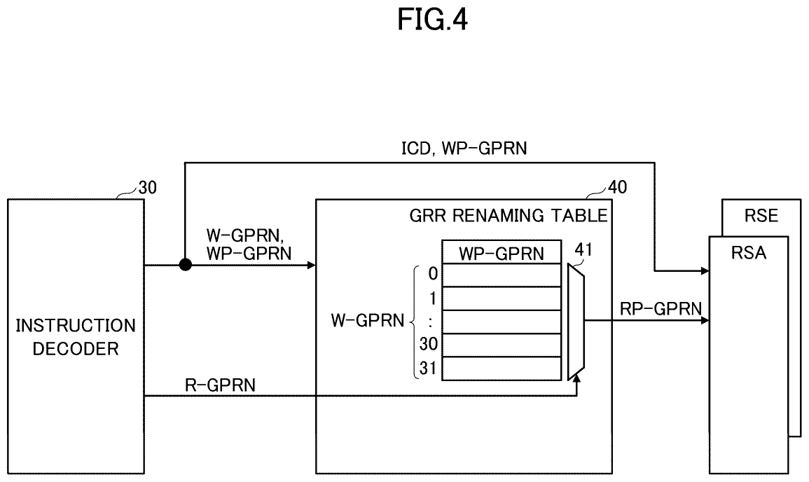

FIG. 4 illustrates an example of the GPR renaming table 40 of FIG. 3. For example, the GPR renaming table 40 has 32 entries corresponding to a number of logical registers that can be specified by an operand included in the arithmetic instruction. Each entry has an area for storing the physical register number WP-GPRN. A number of physical registers that can be specified by the physical register number WP-GPRN is greater than 32.

The instruction decoder 30 stores the write physical register number WP-GPRN in the entry of the GPR renaming table 40 corresponding to the write logical register number W-GPRN indicating the logical register specified by the instruction. In addition, the instruction decoder 30 outputs the read logical register number R-GPRN to the selector 41 of the GPR renaming table 40.

The GPR renaming table 40 reads the write physical register number WP-GPRN from the entry indicated by the read logical register number R-GPRN. The GPR renaming table 40 outputs the read write physical register number WP-GPRN to the RSA or the RSE, as the read physical register number RP-GPRN.

The RSE sequentially holds, in the entries thereof, the instructions (the instruction code ICD, the write physical register number WP-GPRN, and the read physical register number RP-GPRN) received from the instruction decoder 30 and the GPR renaming table 40. Further, the RSE outputs the instructions held in the entries thereof to the fixed-point arithmetic unit 72 illustrated in FIG. 3 in an executable order.

The RSA sequentially holds, in the entries thereof, the instructions (the instruction code ICD, the write physical register number WP-GPRN, and the read physical register number RP-GPRN) received from the instruction decoder 30 and the GPR renaming table 40. Further, the RSA outputs the instructions held in the entries thereof to the address generator 76 illustrated in FIG. 3 in an executable order.

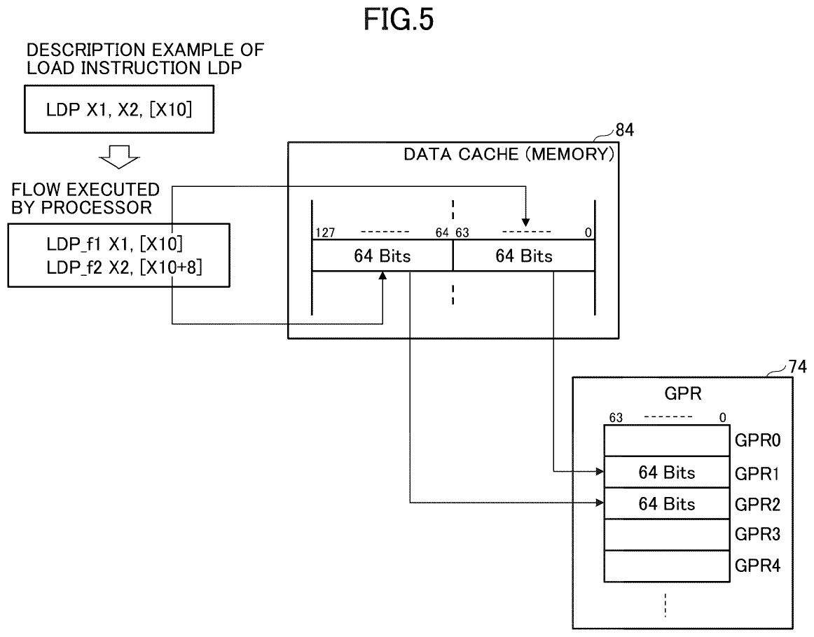

FIG. 5 illustrates an example of an operation in a case where the processor 200 of FIG. 3 executes the load instruction LDP (hereinafter also referred to as the “LDP instruction”). The LDP instruction is an instruction for updating the values of two registers REG by a single instruction, similar to the first load instruction illustrated in FIG. 2, and is described as “LDP X1, X2, [X10]” in the mnemonic, for example.

The processor 200 divides the LDP instruction into two flows f1 and f2, and processes the flows f1 and f2. In the flow f1 (“LDP_f1 X1, [X10]”), the processor 200 reads a first half of 64-bit data from the data cache 84 using an address stored in X10 (for example, GPR10). The processor 200 stores the read data in GPR1. In the flow f2 (“LDP_f2 X2, [X10+8]”), the processor 200 reads the latter half of the 64-bit data from the data cache 84 using an address advanced by 8 bytes (64 bits) from the value stored in X10. The processor 200 stores the read data in GPR2.

When executing the LDP instruction illustrated in FIG. 5, a load instruction for loading 8 bytes is substantially executed twice. For this reason, an IPC (Instruction Per Cycle), which is the number of instructions processed per cycle, is 0.5, which is one-half the IPC=1 for a case where 16 bytes are loaded by a single LDP instruction.

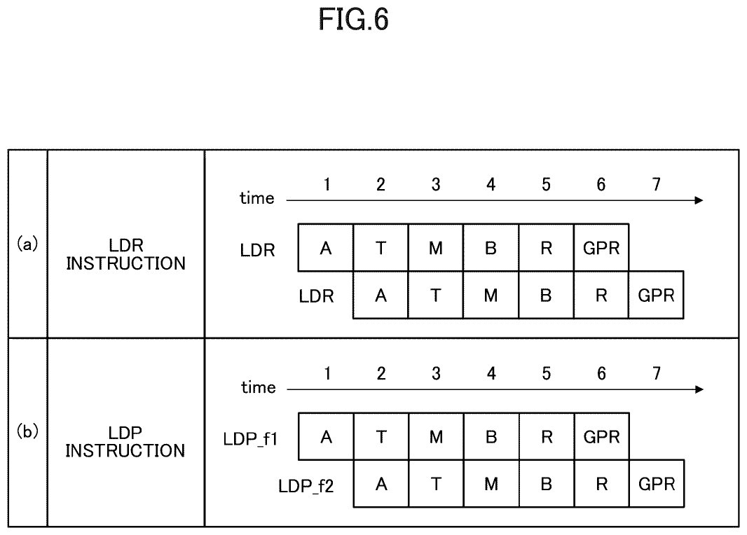

FIG. 6 illustrates an example of a pipeline processing of the load-store unit 80 for the case where the processor 200 of FIG. 3 executes a load instruction LDR (hereinafter also referred to as the “LDR instruction”) and the LDP instruction. In FIG. 6, each of times 1, 2, 3, . . . indicates one cycle, for example.

The LDR instruction is an instruction for reading 8-byte data from the data cache 84 and storing the read data in the GPR in one pipeline operation. The LDP instruction is a load instruction for reading 16 bytes of data from the data cache 84 and storing the read data in two GPRS by two pipeline operations.

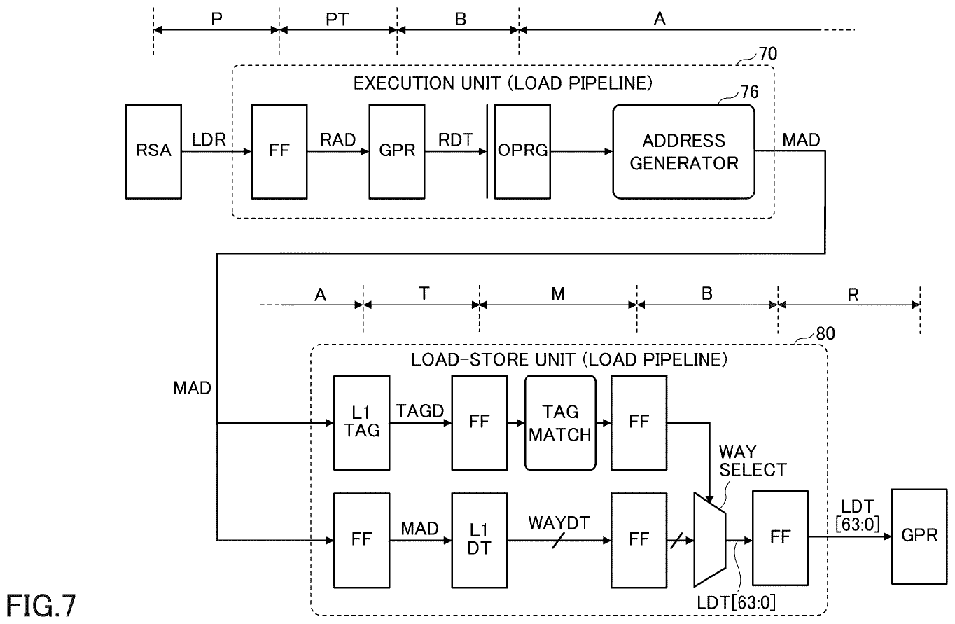

In the pipeline of the load-store unit 80, five stages including an A-cycle, a T-cycle, an M-cycle, a B-cycle, and an R-cycle are sequentially executed, and the data read from the data cache 84 is stored in the GPR. Processing contents of the A-cycle, the T-cycle, the M-cycle, the B-cycle, and the R-cycle will be described later with reference to FIG. 7. A symbol GPR illustrated in the pipeline of FIG. 6 indicates that data is held in the GPR, and does not indicate the processing of the pipeline.

In the pipeline, a plurality of load instructions are executable in an overlapping manner unless the same stage is executed at the same timing. In FIG. 6, (a) illustrates an example in which two LDR instructions are executed successively. In FIG. 6 (a), because the processing of one LDR instruction can be executed in each cycle, the IPC is “1”.

In FIG. 6, (b) illustrates an example in which one LDP instruction is divided into two flows (f1 and f2) and executed. One LDP instruction can be executed only once in two cycles because the pipeline is operated twice, and the IPC becomes “0.5”.

FIG. 7 illustrates an example the pipeline related to the LDR instruction executed by the processor 200 of FIG. 3. In FIG. 7, the P-cycle is a cycle in which the RSA issues the LDR instruction. A PT-cycle is a cycle in which a read address RAD indicating the GPR (entry) of the GPR 74 from which the data is to be read, included in the LDR instruction issued in the P-cycle, is transferred to the GPR 74. The B-cycle is a cycle in which data RDT used by an operation for generating an address is read from the GPR 74.

The A-cycle is a cycle in which the address generator 76 is operated using the data RDT read in the B-cycle to generate a memory address MAD. The operation to generate the address by the address generator 76 may add an immediate value to the data read from the GPR (X10), as “LDR X1, [X10, #8]”. The memory address MAD is transferred to the load-store unit 80.

The T-cycle is a cycle in which tag data TAGD is read from a tag area TAG of the data cache 84 using the memory address MAD generated in the A-cycle. The tag data TAGD includes information indicating whether or not data of a storage area indicated by the memory address MAD is present in a data area DT of the data cache 84.

The M-cycle is a cycle in which a determination is made to determine whether or not the data to be loaded is present in the data area DT of the data cache 84 (determine a cache hit or a cache miss) based on the tag data TAGD (tag match). In the M-cycle, data WATDT is read from the data area DT of the data cache 84 in parallel with the tag match. For example, in a 4-way set associative data cache 84, the data WAYDT of four ways are read as data candidates.

The B-cycle is a cycle in which one of the four ways is selected using the result of the tag match, and the data of the selected way is output as the load data LDT. For example, the load data LDT has 64 bits (8 bytes). The R-cycle is a cycle in which the load data LDT is transferred to the execution unit 70 and stored in the GPR 74.

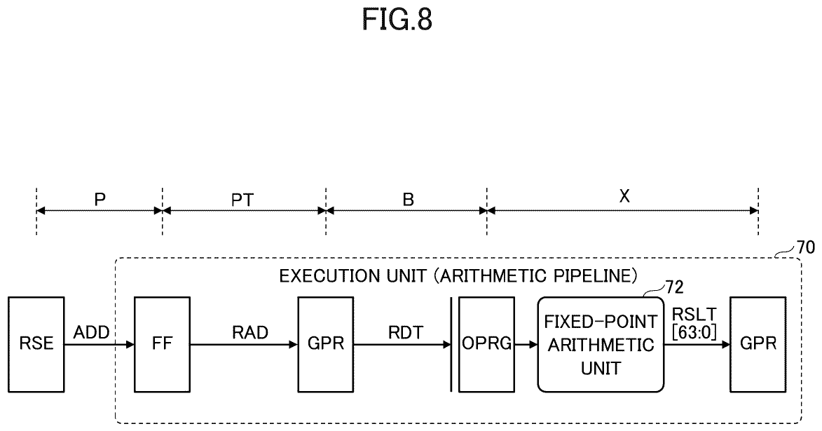

FIG. 8 illustrates an example of a pipeline processing of an arithmetic instruction executed by the processor 200 of FIG. 3. In the pipeline processing of the arithmetic instruction, the P-cycle is a cycle in which the RSE issues the arithmetic instruction. The PT-cycle is a cycle in which the read address RAD indicating the entry of the GPR 74 from which the data is read, included in the arithmetic instruction issued in the P-cycle, is transferred to the GPR 74, and the arithmetic instruction is transferred to the fixed-point arithmetic unit 72.

The B-cycle is a cycle in which the data RDT used for the operation is read from the GPR 74. An X-cycle is a cycle in which the fixed-point arithmetic unit 72 is operated to execute an operation using the data RDT read in the B-cycle, and the arithmetic result data RSLT is generated. The arithmetic result data RSLT has 64 bits (8 bytes), for example, and is stored in one of the entries of the GPR.

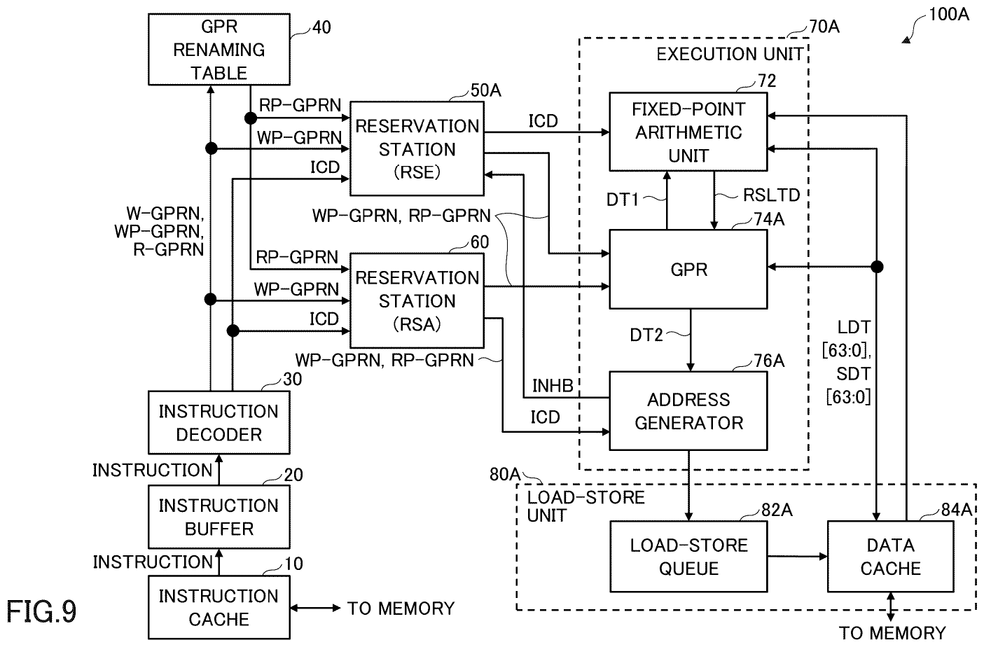

FIG. 9 illustrates an example of a processor according to another embodiment. Constituent elements in FIG. 9 that are the same or similar to the constituent elements in FIG. 3 are designated by the same reference numerals, and a detailed description thereof will be omitted. A processor 100A illustrated in FIG. 9 has the same configuration and function as the processor 200 illustrated in FIG. 3, except that a reservation station 50A, an execution unit 70A, and a load-store unit 80A are provided in place of the reservation station 50, the execution unit 70, and the load-store unit 80 illustrated in FIG. 3. Hereinafter, the reservation station 50A may also be referred to as the RSE. The instruction set architecture of the processor 100A may be an instruction set architecture of ARM Limited, for example.

The execution unit 70A includes a fixed-point arithmetic unit 72, a register (GPR) 74A, and an address generator 76A. The GPR 74A has a plurality of entries. Hereinafter, each entry of the GPR 74A may also be referred to as a GPR, and the data held by each entry may also be referred to as one unit of data. Although not particularly limited, one unit is 8 bytes (64 bits), for example. The address generator 76A outputs inhibition information INHB for inhibiting the RSE from issuing the arithmetic instruction.

The load-store unit 80A includes a load-store queue 82A, and a data cache 84A. The load-store unit 80A reads two units (16 bytes) of data from the data cache 84A when executing the LDP instruction, and transfers the read data to the execution unit 70A as load data LDT [127:0].

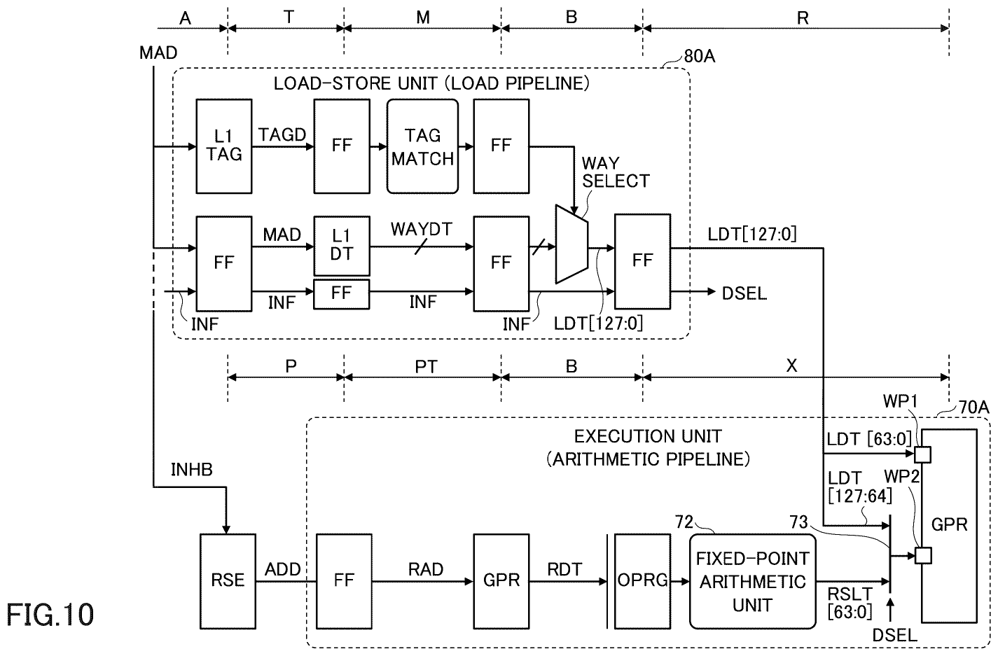

The LDP instruction is a load instruction for simultaneously reading 16 bytes of data from the data cache 84A and storing the read data in two entries of the GPR 74A, as described with reference to FIG. 5 or the like. The LDP instruction is an example of a first load instruction. The processor 100A can execute the LDP instruction in one pipeline operation. An example of the pipeline of the execution unit 70A and the load-store unit 80A is illustrated in FIG. 10.

FIG. 10 illustrates an example of a pipeline related to the LDP instruction executed by the processor 100A of FIG. 9. Elements in FIG. 10 that are the same or similar to the elements in FIG. 7 are designated by the same reference numerals, and a detailed description thereof will be omitted.

In FIG. 10, the operation of the address generator 76A for generating the memory address MAD when executing the LDP instruction is omitted. The operation of the execution unit 70A for a case where the address generator 76A generates the memory address MAD is the same as the operation of the execution unit 70 of FIG. 7. The execution unit 70A executes the P-cycle, the PT-cycle, the B-cycle, and the A-cycle when executing the LDP instruction, and generates the memory address MAD from the address generator 76A.

The address generator 76A generates the memory address MAD and outputs the inhibition information INHB to the RSE when executing the LDP instruction. The RSE inhibits the issuance of the arithmetic instruction in a cycle next to the cycle in which the inhibition information INHB is received.

The load pipeline of the load-store unit 80A has a T-cycle, an M-cycle, a B-cycle, and an R-cycle, similar to FIG. 7. The arithmetic pipeline when executing the operation by the execution unit 70A has a PT-cycle, a B-cycle, and an X-cycle, similar to FIG. 8.

The load-store unit 80A has a function of reading two units of load data LDT [127:0] from the data cache 84A. In addition, the load-store unit 80A has a function of transmitting information INF indicating the execution of the LDP instruction in the pipeline when executing the LDP instruction, and outputting the information INF as data selection information DSEL. For this reason, the way select of the load-store unit 80A selects two ways corresponding to two units of data when executing the LDP instruction. Otherwise, the configuration and functions of the load-store unit 80A are the same as the configuration and functions of the load-store unit 80 of FIG. 7.

The execution unit 70A includes a selector 73 which selects either load data LDT [127:64] from the load-store unit 80A or arithmetic result data RSLT [63:0] from the fixed-point arithmetic unit 72 and outputs the selected data to the GPR 74A. The GPR 74A has write ports WP1 and WP2, similar to the register file 7 of FIG. 2. The write port WP1 receives the load data LDT [63:0] from the load-store unit 80A, and the write port WP2 receives the load data LDT [127:64] or the arithmetic result data RSLT [63:0] from the selector 73.

When the selector 73 receives the data selection information DSEL (for example, when the data selection information DSEL has a valid level), the selector 73 selects and outputs the load data LDT [127:64] to the write port WP2. When the selector 73 does not receive the data selection information DSEL (for example, when the data selection information DSEL has an invalid level), the selector 73 selects and outputs the arithmetic result data RSLT [63:0] to the write port WP2.

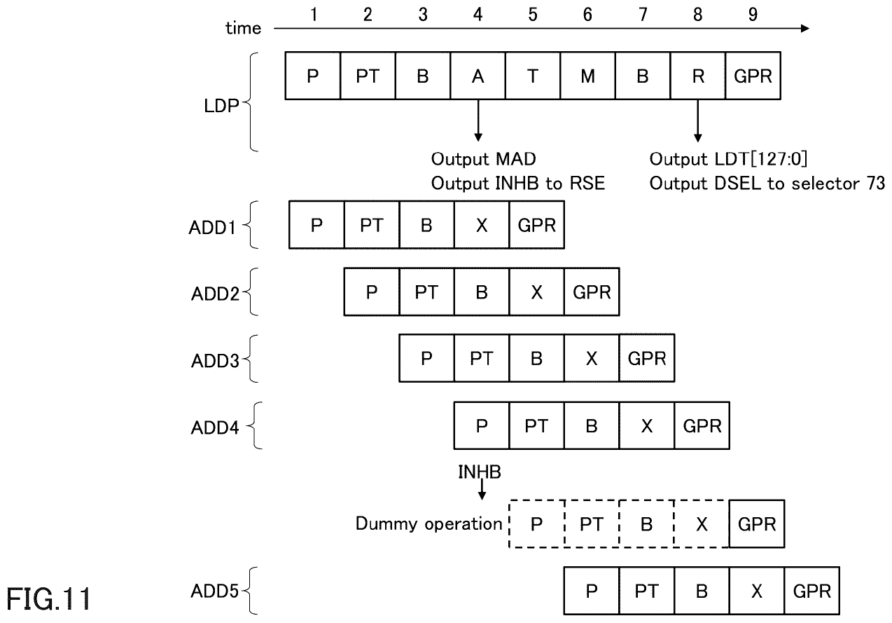

FIG. 11 illustrates an example of a pipeline processing in a case where the LDP instruction and the arithmetic instruction are executed in parallel in the processor 100A of FIG. 9. A detailed description of the operations that are similar to those of FIG. 6 through FIG. 8 will be omitted. The LDP instruction is executed using eight cycles from the P-cycle to the R-cycle, similar to FIG. 7. The arithmetic instruction is executed using four cycles from the P-cycle to the X-cycle, similar to FIG. 8. In FIG. 11, it is assumed for the sake of convenience that an addition instruction ADD is executed as the arithmetic instruction. A number added to the end of the addition instruction ADD indicates the execution order of the addition instruction ADD. In FIG. 11, each of times 1, 2, 3, . . . indicates one cycle, for example.

In FIG. 11, the load pipeline for executing the LDP instruction and the arithmetic pipeline for executing the arithmetic instruction operate in parallel. The arithmetic pipeline executes the arithmetic instruction in each cycle except for the cycle next to the cycle in which the inhibition information INHB is output from the load pipeline.

The load pipeline which receives the LDP instruction at time=1 outputs the memory address MAD and outputs the inhibition information INHB to the RSE in the A-cycle executed at time=4. The RSE does not issue an arithmetic instruction in the cycle next to the cycle in which the inhibition information INHB is received. For this reason, the RSE sequentially issues the addition instructions ADD1 to ADD4 at time=1 to time=4, and thereafter issues the next addition instruction ADD5 at time=6 after a vacant interval of one cycle. The arithmetic pipeline which does not receive the arithmetic instruction executes a dummy operation using invalid information from time=5 to time=8.

By causing the arithmetic pipeline to execute the dummy operation, the arithmetic pipeline does not have to be stopped even in a case where the issuance of the arithmetic instruction is inhibited, and thus, the arithmetic instruction already being processed in the arithmetic pipeline can be executed in a normal manner.

At time=8, the load pipeline outputs the load data LDT [127:0], and outputs the data selection information DSEL having the valid level to the selector 73. That is, the load pipeline outputs the data selection information DSEL to the selector 73 in accordance with the timing when the load data LDT [127:0] is output to the selector 73, based on the LDP instruction. The selector 73 selects the load data LDT [127:64] output from the load pipeline at time=8 when the data selection information DSEL having the valid level is received, and outputs the selected load data LDT [127:64] to the write port WP2 of the GPR 74A.

Accordingly, the write port WP1 and the write port WP2 for the arithmetic result data RSLT can be used to simultaneously write two units of load data LDT [127:64] and LDT [63:0] to the two entries of the GPR 74A. Hence, the two entries of the GPR 74A can be updated by the two units of load data LDT [127:64] and LDT [63:0] by the LDP instruction, without having to newly provide a write port for the load data LDT [127:64]. As a result, it is possible to reduce an increase in the circuit scale of the GPR 74A. Further, it is possible to prevent invalid arithmetic result data RSLT due to a dummy operation by the arithmetic pipeline from being stored in the GPR 74A.

In addition, the selector 73 can inhibit only the execution of the addition instruction ADD that generates the arithmetic result data RSLT conflicting with the load data LDT [127:64]. In other words, the addition instruction ADD that generates the arithmetic result data RSLT not conflicting with the load data LDT [127:64] can be executed without being inhibited, and an erroneous operation of the processor 100A can be prevented.

For example, the address generator 76A outputs the inhibition information INHB at a timing when the arithmetic instruction for outputting the arithmetic result data RLST is issued when the load data LDT [127:64] is output to the selector 73 by the LDP instruction, and inhibits the issuance of the arithmetic instruction. In other words, the output timing of the inhibition information INHB to the RSE is set so that the number of cycles from the output of the inhibition information INHB to the output of the load data LDT is equal to the number of cycles from the issuance of the arithmetic instruction to the output of the arithmetic result data RSLT.

That is, the inhibition information INHB is output in cycles obtained by subtracting the number of execution cycles (four cycles in FIG. 11) of the arithmetic instruction from the cycles in which the load data LDT is output. For this reason, in a case where the operation cycle is five cycles, for example, the inhibition information INHB is output in the B-cycle, and in a case where the operation cycle is three cycles, the inhibition information INHB is output in the T-cycle.

As described above, it is possible to prevent the load data LDT [127:64] and the arithmetic result data RSLT from conflicting with each other at time=8 when the load data LDT [127:64] is output from the load pipeline by the LDP instruction. That is, even in a case where the write port WP2 is shared by the load data LDT [127:64] and the arithmetic result data RSLT, it is possible to reduce the generation of simultaneous writing of the data to the GPR 74A, and prevent the erroneous operation of the processor 100A.

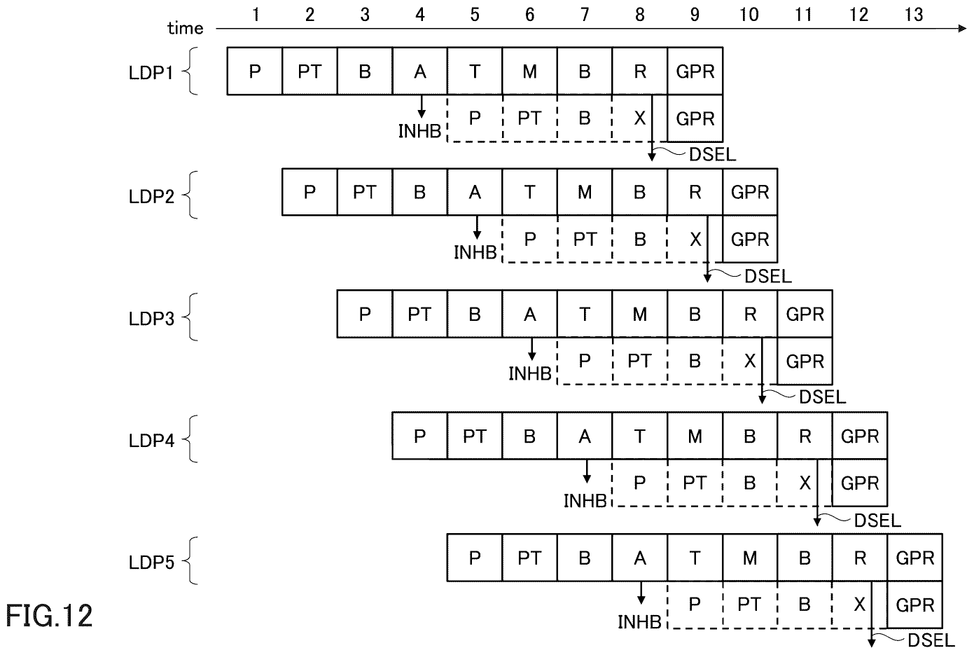

FIG. 12 illustrates an example of a pipeline processing in a case where a plurality of LDP instructions are sequentially executed in the processor 100A of FIG. 9. A detailed description of the operations that are similar to those of FIG. 6 through FIG. 8 and FIG. 11 will be omitted. In FIG. 12, the load pipeline receives the LDP instruction from the RSE in each cycle, and sequentially executes the LDP instructions. A number added to the end of the LDP instruction indicates the execution order of the LDP instruction.

The load pipeline outputs the inhibition information INHB in the A-cycle and outputs the valid data selection information DSEL in the R-cycle by each LDP instruction.

The inhibition information INHB is used for inhibiting the issuance of the arithmetic instruction from the RSE, and does not affect the LDP instruction issued from the RSA. For this reason, the RSA can issue the LDP instruction in each cycle, and the load pipeline can execute the LDP instruction in each cycle. Accordingly, the LDP instruction for updating two units of data in two entries of the GPR 74A can be executed at IPC= “1”. As a result, the LDP instruction for simultaneously updating the two entries of the GPR 74A can be executed without increasing the number of write ports of the GPR 74A, and the data load processing performance can be improved compared to the processor 200 of FIG. 3, while reducing an increase in the circuit scale.

For example, the LDP instruction may be diversified into a so-called spill/fill processing in which data within the GPR 74A is temporarily saved in a memory, a vacant area of the GPR 74A is used for another purpose, and data is rewritten to the GPR 74A from the memory, as required. For this reason, the LDP instructions are executed continuously in many cases, and a throughput thereof is important. In the case where the LDP instruction is divided into two flows and executed as a normal LDR instruction as illustrated in FIG. 6, an expected throughput may not be obtainable.

As described above, this embodiment can obtain the same effects as those obtainable in embodiment described above. For example, the selector 73 is provided between the output of the fixed-point arithmetic unit 72 and the write port WP2 of the GPR 74A, so as to output either the arithmetic result data RSLT or the load data LDT [127:64] from the load-store unit 80A to the write port WP2. Thus, the two units of load data LDT [127:64] and LDT [63:0] can be simultaneously written into the two entries of the GPR 74A by the LDP instruction, without having to newly provide a write port WP. Accordingly, it is possible to improve the processing performance of the processor 100A that executes the LDP instruction, while reducing an increase in the circuit scale of the processor 100A.

Further, in this embodiment, the address generator 76A outputs the inhibition information INHB for inhibiting the issuance of the arithmetic instruction for outputting the arithmetic result data RLST in the cycle in which the load data LDT [127:64] by the LDP instruction is output to the selector 73. For example, the output timing of the inhibition information INHB to the RSE is set so that the number of cycles from the output of the inhibition information INHB to the output of the load data LDT becomes equal to the number of cycles from the issuance of the arithmetic instruction to the output of the arithmetic result data RSLT. Thus, even in the case where the write port WP2 is shared by the load data LDT [127:64] and the arithmetic result data RSLT, it is possible to prevent the generation of simultaneous writing of the data to the GPR 74A, and prevent the erroneous operation of the processor 100A.

By causing the arithmetic pipeline to execute the dummy operation based on the inhibition information INHB, the arithmetic pipeline does not have to be stopped even in the case where the issuance of the arithmetic instruction is inhibited, and thus, the arithmetic instruction already being processed in the arithmetic pipeline can be executed in a normal manner.

The load-store unit 80A outputs the data selection information DSEL to the selector 73 in a cycle in which the load data LDT [127:64] read from the data cache 84A based on the LDP instruction is output. For this reason, the selector 73 can select and output the load data LDT [127:64] to the write port WP2 in accordance with the timing when the load data LDT [127:64] is output from the load-store unit 80A.

The load-store unit 80A transmits the information INF indicating the execution of the LDP instruction in the pipeline when executing the LDP instruction, and outputs the information INF as the data selection information DSEL. Thus, the data selection information DSEL can be generated by sequentially transmitting the LDP instructions issued from the RSA in the load-store unit 80A, without having to provide a special circuit, such as a generation circuit or the like for generating the data selection signal, for example.

By improving the processing performance of the processor described above, it is possible to improve the processing performance of a system, such as a server or the like provided with the processor, and reduce the time required for scientific and technical calculations, deep learning, various simulations, or the like.

According to one aspect of the embodiments of the present disclosure, it is possible to improve a processing performance of a processor that executes a load instruction for loading a plurality of data into a plurality of registers of a register file in parallel, while reducing an increase in a circuit scale.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A processor comprising:
an arithmetic pipeline including an arithmetic unit configured to execute an arithmetic instruction and output arithmetic result data;
a load pipeline configured to read first data and second data in parallel from a memory based on a first load instruction, and output the read first data and second data;
a selector configured to select the second data when the second data is output from the load pipeline, and select an output of the arithmetic unit when the second data is not output from the load pipeline; and
a register file including a first port configured to receive the first data from the load pipeline, a second port configured to receive data from the selector, and a plurality of registers configured to hold data received by the first port or the second port,
wherein the first data and the second data are stored in mutually different registers.

2. The processor as claimed in claim 1, further comprising:
an instruction issuer configured to issue the arithmetic instruction,
wherein the load pipeline outputs, to the instruction issuer, inhibition information for inhibiting issuance of the arithmetic instruction for outputting the arithmetic result data to the selector in a cycle identical to a cycle in which the second data is output to the selector based on the first load instruction.

3. The processor as claimed in claim 2, wherein an output timing of the inhibition information to the instruction issuer is set so that a number of cycles from the output of the inhibition information to the output of the second data to the selector is equal to a number of cycles from the issuance of the arithmetic instruction to the output of the arithmetic result data to the selector.

4. The processor as claimed in claim 2, wherein the arithmetic pipeline, inhibited of the issuance of the arithmetic instruction from the instruction issuer, executes a dummy arithmetic operation.

5. The processor as claimed in claim 1, wherein the load pipeline outputs, to the selector, data selection information for causing the selector to select the second data, in a cycle in which the second data is output to the selector.

6. The processor as claimed in claim 5, wherein the load pipeline generates the data selection information using information indicating execution of the first load instruction transmitted within the load pipeline.
